(19) United States
(12) Patent Application Publication
(10) Pub. No.: US 2006/0027389 A1
(43) Pub. Date: Feb. 9, 2006

(54) Universal switch assembly

(76) Inventors: Shaojie Xu, Overland Park, KS (US); Hui Xu, Shanghai (CN)

Correspondence Address: Arthur Shaffer;Intellectual Property Center LLC, 14072 West 115th Street, Olathe, KS, 66062, US

(21) Appl. No.: 10/910,122

(22) Filed: Aug. 4, 2004

(51) Int. Cl. H02G 3/14

(52) U.S. Cl. 174/66

(57) ABSTRACT

A novel cover plate assembly comprising of a face plate and a base plate for mounting a switch mechanism having a yoke plate with the spacing of screw holes at the yoke plate the same as that of a wall box and that of said base plate provides a universal switch mounting system for any devices of any types. The decorative face plate is free of mounting screw holes and is snapped into the base plate through a snap fit connection. The cover plate assembly made of metal is suitable for high-class wall decorations.

### FIELD OF THE INVENTION

This invention relates to a novel covering assembly for a wall box mounted switch, receptacle or other device of the type which employs an integral yoke plate having standard screw holes at the yoke plate positioned the same as those at a wall box.

### BACKGROUND OF THE INVENTION

Wall box mounted devices and switches are well known. Conventional cover plate assemblies world widely used are mounted on switch devices or frames or yoke plates carried with switch mechanisms. Switch manufacturers in some countries produce cover plate assemblies based on the mounting structures of their own switch devices. The traditional concept guides inventors to invent various decorative switch cover plate assemblies based on the types of switch devices provided and the mounting rules established by the switch manufacturers.

Besides, conventional switch cover plate assemblies are either made of plastic to hide mounting screws or made of metal to expose mounting screws. Conventional switch cover plates with the face plate free of mounting screws are not suitable for metal structures with snap fit connections because the metal snaps are subject to breaking at installation. As a matter of fact, metal plates have better decorative appearances than those of plastic ones.

Although wall boxes for switch devices are in universal standard, conventional cover plate assemblies for switch devices are not. A universal cover plate assembly for a universal switch device has many obvious advantages. Manufacturers shall have more broad sales markets world widely. House owners shall have more choices in selecting decorative covering assemblies from the world wide market. Manufacturers shall also find that a universal cover plate can greatly reduce number of production molds for decorative covering plates. The advantages provide tremendous benefits to both house owners and manufacturers.

As a matter of fact, screw holes for wall box mounted switch devices are positioned in universal standard. A switch mechanism having a yoke plate with screw holes positioned in universal standard can be provided as a universal switch device. A cover plate assembly with its mounting structure independent from a switch device and having its screw holes aligned with those at a wall box can also be provided as a universal cover plate assembly.

In combination, a novel cover plate assembly made of metal with face plate free of screw holes for a switch mechanism having a yoke plate with screw holes positioned in universal standard is not solved by prior art devices.

### BACKGROUND OF INVENTION—OBJECTS AND ADVANTAGES

Accordingly, a principal object of the present invention is to provide a switch mechanism having a simple yoke plate and a novel cover plate assembly comprising of a base plate and a face plate. The face plate is free of mounting screw openings.

An important object of the invention is to fabricate a cover plate assembly from metal so that better structure quality and decorative appearance can be provided.

Another object of the invention is to provide a universal cover plate assembly having a snap fit connection between the face plate and the base plate.

Another object of the invention is to provide a universal cover plate assembly which is demountable and replaceable.

Another object of the invention is to provide a universal cover plate assembly having the base plate mounted to a wall box instead of a switch device.

Another object of this invention is to provide the base plate as an independent platform to receive switch devices and to maintain alignment of the switch device against the wall.

Another object of the invention to provide a switch mechanism having a yoke plate with round-shaped screw holes spaced the same as those at the base plate and those at a wall box. Ears for alignment and threaded screw holes for conventional cover plates at yoke plates of switch devices of prior art are useless for the structure of the present invention.

Another object of the invention is to fabricate the face plates from steel plate by employing punch presses. The orifices at face plates are punched at the last stage with separated molds for the shapes of the orifices.

### SUMMARY OF THE INVENTION

The present invention systematizes a novel cover plate assembly and a switch mechanism having a yoke plate as a universal wall box mounting structure for any devices of any types. The cover plate assembly can be made of metal to provide noble appearances for wall decorations. The novel cover plate assembly comprises of a face plate and a base plate with the face plate free of mounting screws. The face plate is snapped into the base plate by a snap fit connection. The switch mechanism is mounted to a wall box through a yoke plate together with the base plate. The base plate has an opening sufficiently large to receive switch devices.

### BRIEF DESCRIPTION OF THE DRAWINGS

FIG. 1 is an exploded perspective view of a preferred embodiment of the switch cover plate assembly of the invention for a switch mechanism having a simple yoke plate.

FIG. 2 is a perspective view of the face plate and the base plate shown in FIG. 1, showing the rear side of the face plate and the base plate as well as the inwardly projected snaps bent from steel plate.

FIG. 3 is a sectional view of the snap fit connection for the face plate made from steel plate with snaps projected inwardly.

FIG. 4 is a front elevation view of the base plate shown in FIG. 1.

FIG. 5 is a sectional view of the base plate taken along the line 1-1.

FIG. 6 is a sectional view of the base plate taken along lines 2-2.

FIG. 7 is a sectional view of the base plate taken along lines 3-3.

FIG. 8 is a sectional view of the base plate taken along lines 4-4.

FIG. 9 is a front elevation view of the face plate shown in FIG. 1.

FIG. 10 is a sectional view of the face plate taken along lines 5-5.

FIG. 11 is a sectional view of the face plate taken along lines 6-6.

FIG. 12 is a sectional view of the face plate taken along lines 7-7.

FIG. 13 is a sectional view of the face plate taken along lines 8-8.

FIG. 14 is a perspective view of the switch device.

FIG. 15 is a sectional view of the installed switch device and the cover plate assembly of this invention.

FIG. 16 is a perspective view of a molded base plate and a molded face plate for an alternative embodiment of the present invention, showing the rear side of the two plates and the molded snaps carried by the face plate.

FIG. 17 is a sectional view of a snap fit connection for the molded base plate and the molded face plate shown in FIG. 16, showing the molded snaps projected inwardly.

FIG. 18 is an exploded perspective view of an alternative cover plate assembly of the present invention, showing that the face plate and the base plate are molded with corresponding snaps and snap receiving openings.

FIG. 19 is a sectional view of the installed switch device and the cover plate assembly of the alternative embodiment of the present invention shown in FIG. 18.

FIG. 20 is an exploded perspective of an alternative embodiment of the present invention for a toggle switch mechanism having a simple yoke plate.

### DRAWINGS—REFERENCE NUMERALS

70 wall box

71 and 72 screw hole

60 base plate

61 and 62 screw hole

63, 64, 65 and 66 snap receiving opening

68 edge

69 central opening

40 switch device

45 switch mechanism

46 control member

43 yoke plate

41 and 42 screw hole

31 and 32 screw

20 face plate

21, 22, 23 and 24 snap

26 orifice

81 and 82 prying hole

91, 92, 93 and 94 screw

101, 102, 103 and 104 screw hole

201, 202, 203 and 204 screw hole

### DETAILED DESCRIPTION

I. Preferred Embodiment Switch Cover Plate Assembly

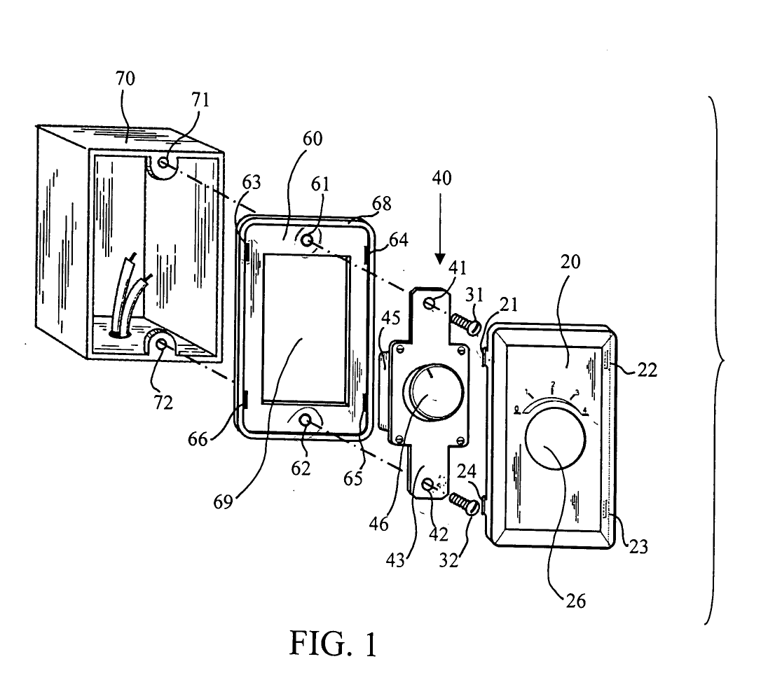

Referring first to FIG. 1, an exploded perspective view of a preferred embodiment of a switch cover plate assembly for a switch device having a simple yoke plate. Wall box 70 is a common wall box to be mounted within the wall of a building. Threaded screw holes 71 and 72 at wall box 70 are on standard centers and are adapted to receive at least one fastener or mounting screws for mounting a switch device within wall box 70.

Base plate 60 has cover plate openings or screw holes 61 and 62 which match the center-to-center spacing of threaded screw holes 71 and 72. Snap receiving openings 63, 64, 65 and 66 are symmetrically located next to the inner periphery of edge 68, which are aligned with snaps 21, 22, 23, 24 at face plate 20 for a snap fit connection. Central opening 69 is adapted for receiving switch device 40. Central opening 69 is also adapted for passage of switch device 40 with connected wires moved from the rear side of base plate 60 to the front side for cover plate assembly replacement. The inner periphery of edge 68 at base plate 60 is slightly large than the outer periphery of face plate 20 so that base plate 60 can receive face plate 20.

Switch device 40 is of the type for fan speed control. The present invention applies to any other types of switch mechanisms or devices for lighting and the like. Switch device 40 consists of a switch mechanism 45, a yoke plate 43 and a control member 46. Switch mechanism 45 is lifted and supported by yoke plate 43 to be connected to wall box 70 through base plate 60. Yoke plate 43 preferably is a generally flat thin metal plate. However, it can also be molded of flame retardant materials such as plastic as long as it is strong enough to carry switch mechanism 40. Screw holes 41 and 42 at yoke plate 43 of this invention are in round shape having a diameter slightly larger than the one of the screw. Conventional switch devices provide laterally elongated openings for positioning alignment at installation. Such positioning alignment, however, is not necessary for installation of switch device 40 with the cover plate assembly of the present invention. Considering the wide use of conventional cover plates, it is optional to keep conventional threaded screw mounting holes at yoke plate 43 of the present invention for mounting cover plates of prior art.

Screws holes 41 and 42 at yoke plate 43 are on a spacing equal to that of screw holes 61 and 62 at base plate 60 and screws holes 71 and 72 at wall box 70. Fasteners or screws 31 and 32 pass through screw holes 41 and 42 and screw holes 61 and 62, respectively, and are threaded into screw holes 71 and 72 respectively to mount both base plate 60 and switch device 40 to wall box 70 at the same time. Base plate 60 mounted to wall box 70 maintains alignment of switch device 40 and receives face plate 20 stably. As it is seen, the cover plate assembly with base plate 60 is not mounted into switch device 40 but into wall box 70. The cover plate assembly is therefore an independent structure from switch devices. Conventional cover plate assemblies are used to be mounted into switch devices or yoke plates or special frames carried with switch mechanisms.

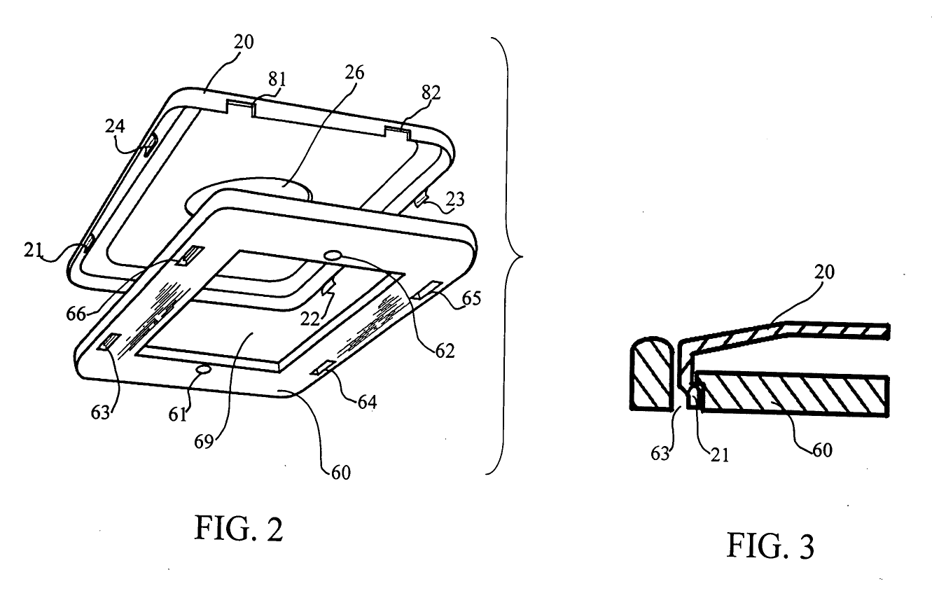

Face plate 20 is snapped into base plate 60 for interlocking engagement. Orifice 26 at face plate 20 is adapted to permit control member 46 of switch device 40 to extend through face plate 20. A snap connection structure is illustrated in FIGS. 2 and 3 having snap connectors or snaps which are preferably elongated and snap receiving openings or receivers for connecting said face plate to said base plate. Snaps 21, 22, 23 and 24 which are geometrically located along the periphery of face plate 20 and are aligned with corresponding snap receiving openings 63, 64, 65 and 66 at base plate 60, respectively. Face plate 20 for this preferred embodiment is fabricated from steel plate at a thickness of 0.8 mm by employing a punch press. The snaps 21, 22, 23 and 24 are therefore bent from steel plate. The snaps bent from steel plate are not subject to breaking at installation.

FIG. 2 is a perspective view of face plate 20 and base plate 60, showing the rear side of face plate 20 and base plate 20. It also shows snaps 21, 22, 23 and 24 bent from steel plate projected inwardly for a snap fit connection with snap receiving openings 63, 64, 65 and 66 at base plate 60.

FIG. 3 is an enlarged snap fit connection structure for face plate 20 and base plate 60. Face plate 20 as shown is fabricated from steel plate. Base plate 60 is molded of casting metal for this preferred embodiment. It can also be molded of any flame retardant materials such as porcelain and polycarbonate.

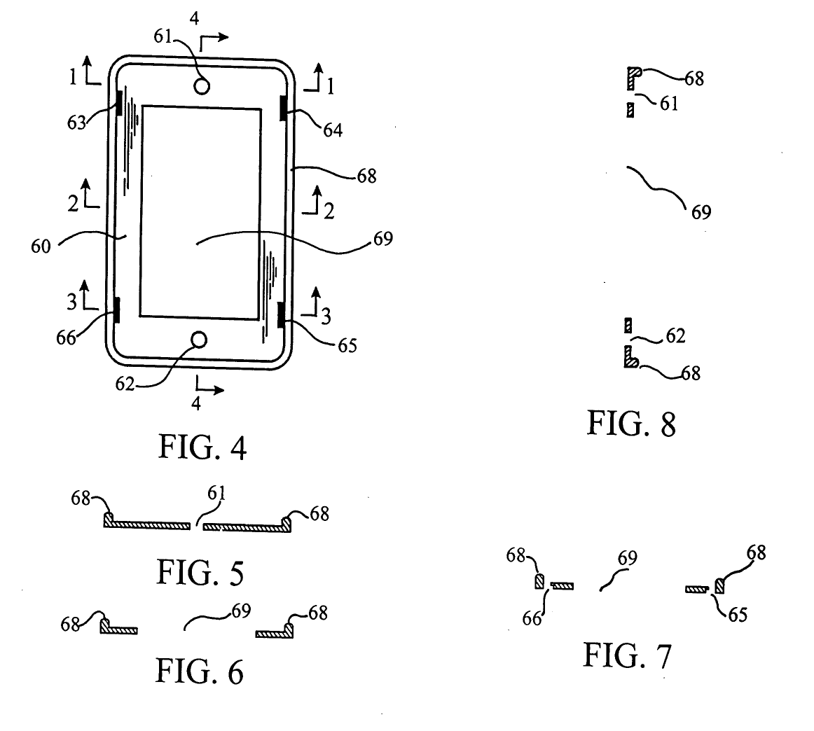

FIG. 4 is a front elevation view of base plate 60 shown in FIG. 1. Snap receiving openings 63, 64, 65 and 66 are symmetrically located adjacent to the inner periphery of edge 68. The inner periphery of edge 68 is slightly larger than the outer periphery of face plate 20 so that base plate 60 can receive face plate 20. Screw holes 61 and 62 are spaced the same as the center-to-center spacing of screws holes at wall box 70. Central opening 69 is sufficiently large to receive switch device 40.

FIG. 5, FIG. 6, FIG. 7 and FIG. 8 are sectional views of base plate 60 shown in FIG. 4 taken along lines 1-1, 2-2, 3-3 and 44, respectively. As shown, base plate 60 is a simple structure and can be molded of any flame retardant materials. Alternatively, the structure of the base plate of the present invention can also be fabricated from steel plate by employing a punch press.

FIG. 9 is a front elevation view of face plate 20 shown in FIG. 1. Orifice 26 is centrally located at face plate 20 with its periphery slightly larger than the periphery of control member 46 at switch device 40 so that control member 46 can extend through orifice 26. For switch devices having more than one control member, the orifices are not arranged in center as shown for this preferred embodiment but aligned with the corresponding control members. Orifice 26 is punched at the last stage of production with a separated mold. Separated molds for orifices determine whether or not the cover plate assembly shall be used for a cable outlet or blank plate or receptacle. A manufacturer can reduce great number of molds at production. The manufacturer will gain great benefits at budget saving to have the same assembly molds used for different outlets.

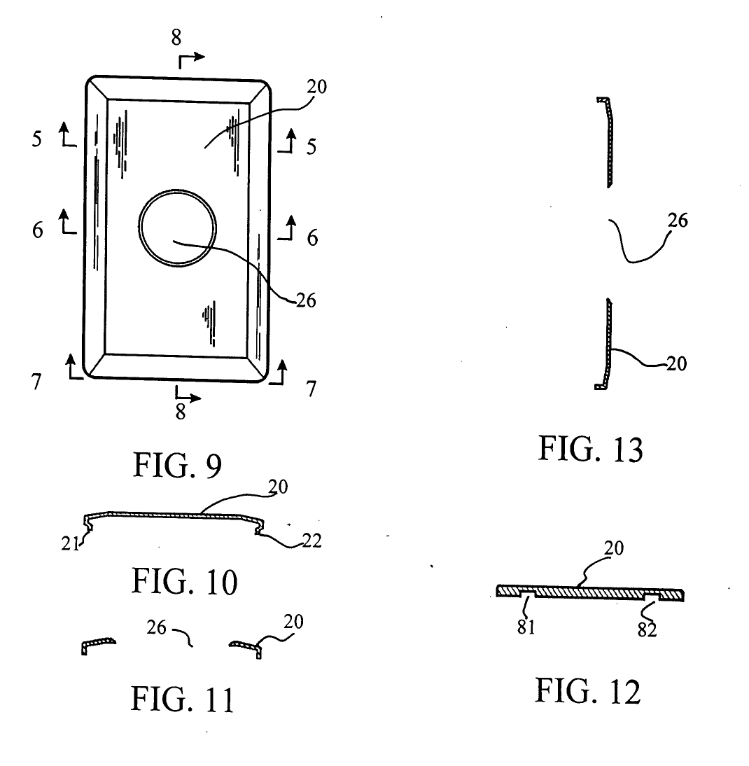

FIG. 10, FIG. 11, FIG. 12 and FIG. 13 are sectional views of face plate 20 shown in FIG. 9 taken along lines 5-5, 6-6, 7-7 and 8-8, respectively. Snaps 21 and 22 shown in FOG. 10 extend from the periphery of face plate 20 and are bent inwardly from steel plate. Holes 81 and 82 shown in FIG. 12 are adapted for passing through a head of a screwdriver for prying purpose to demount face plate 20 from interlocking engagement with base plate 60.

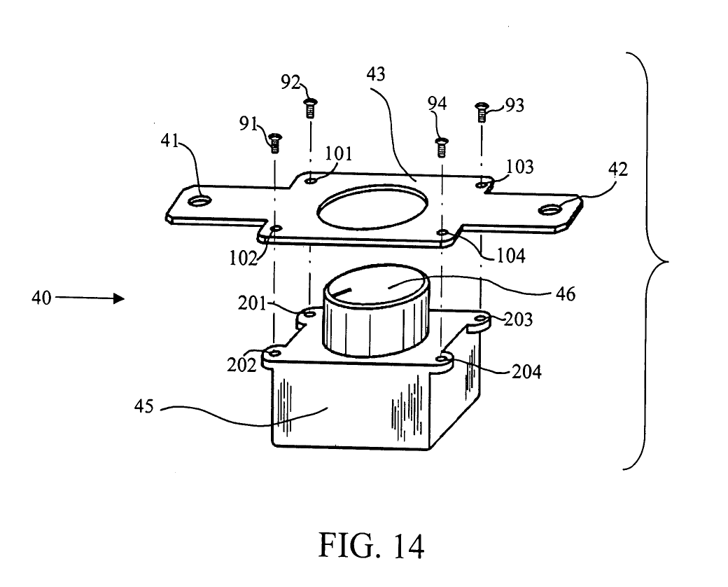

Referring now to FIG. 14, switch device 40 comprises of yoke plate 43, control member 46 and switch mechanism 45. Screw holes 41 and 42 are on a spacing equal to that of screw holes 71 and 72 at wall box 70 shown in FIG. 1. Screw holes 101, 102, 103 and 104 at yoke plate 43 are aligned with threaded screw holes 201, 202, 203 and 204 at switch mechanism 45. Screws 91, 92, 93 and 94 pass through screw holes 101, 102, 103 and 104 and screw holes 201, 202, 203 and 204, respectively, to mount yoke plate 43 into switch mechanism 45. Alternatively, other attachment means can also be used to attach yoke plate 43 into switch mechanism 45. Ears for alignment and threaded screw holes at yoke plates of prior art for conventional cover plates are useless for the present invention. As it is seen, the combination of a yoke plate and a cover plate assembly of the present invention having corresponding wall-box mounting screw holes positioned in universal standard provides a universal wall-box mounting system for any switch mechanisms or devices of any types.

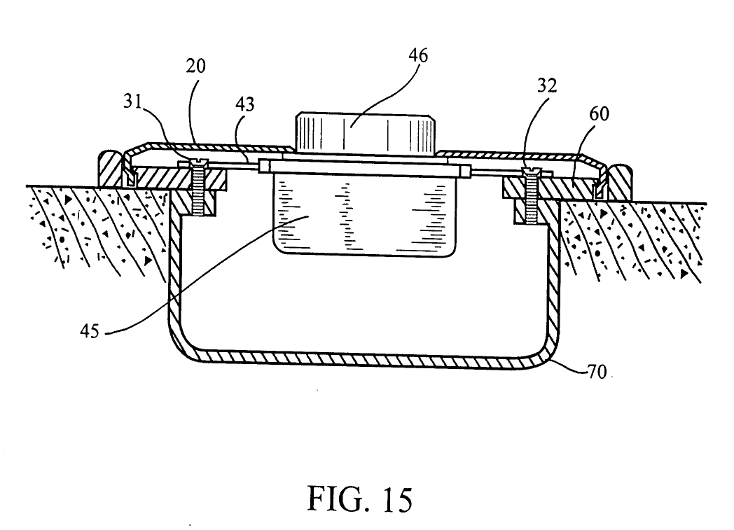

FIG. 15 shows installed switch device 40 with face plate 20 snapped into base plate 60. Switch mechanism 45 is mounted to wall box 70 through yoke plate 43 together with base plate 60. Face plate 20 is not mounted into yoke plate 43 as the conventional way for face plates of prior art. Furthermore, base plate 60 provides an independent interlocking structure for face plate 20 so that shapes of the cover plate assembly of the present invention can be arranged in any pleasing ones such as flowers and buildings with face plate 20 free of mounting screw holes.

III. Alternative Embodiment Switch Cover Plate Assembly

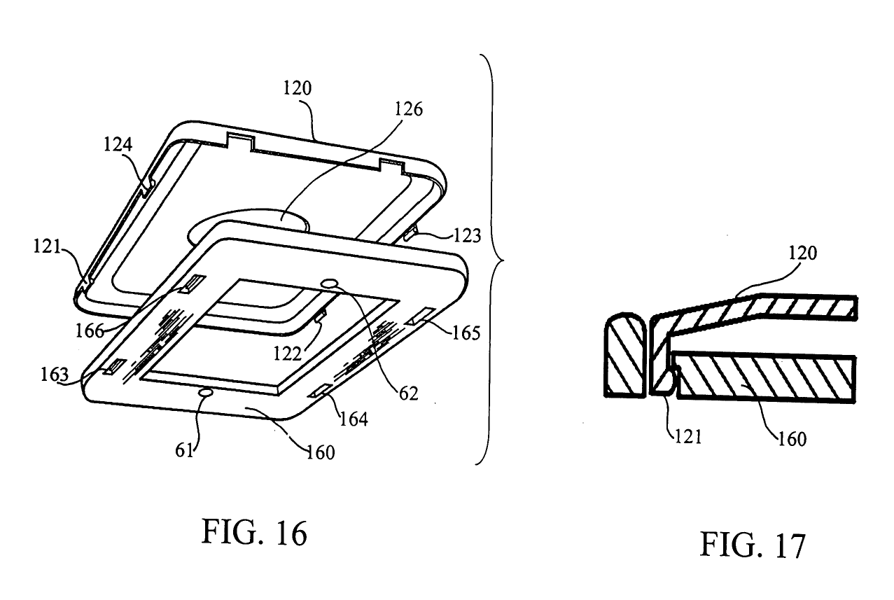

Alternatively, the components of the cover plate assembly of the present invention can also be molded of any materials such as plastic. FIG. 16 shows the rear side of molded face plate 120 and molded base plate 160 for an alternative embodiment of the present invention. Molded snaps 121, 122, 123 and 124 at face plate 120 are projected inwardly, which are aligned with snap receiving openings 163, 164, 165 and 166 at base plate 160. Screws holes 61 and 62 at base plate 160 are spaced the same as the center-to-center spacing of the threaded screw holes at a wall box. The detailed snap fit connection between molded face plate 120 and base plate 160 is shown in FIG. 17.

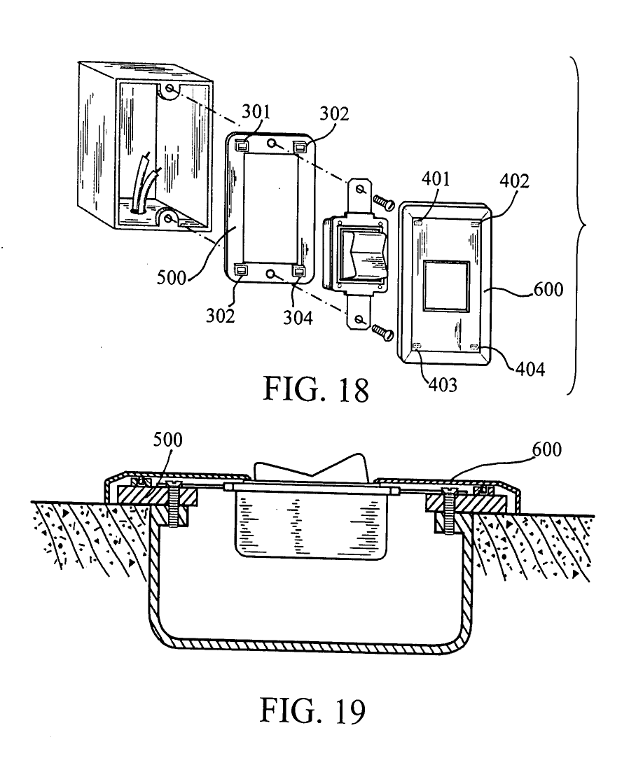

The second alternative embodiment of the present invention is to arrange snaps at a molded face plate and snap receiving openings at a molded base plate at locations other than those shown in the preferred embodiment. Referring now to FIG. 18, snaps 401, 402, 403 and 404 extend from the rear side of the molded face plate 600, which are aligned with snap receiving openings 301, 302, 303 and 304 at the molded base plate 500. Referring to FIG. 19, the molded face plate 600 is snapped into the molded base plate 500 through a snap fit connection. The base plate 500 is not exposed to the eye of the observer after the face plate 600 is in place. The cover plate assembly of the present invention with the molded face plate and base plate can also provide any decorative shapes with the face plate free of mounting screws.

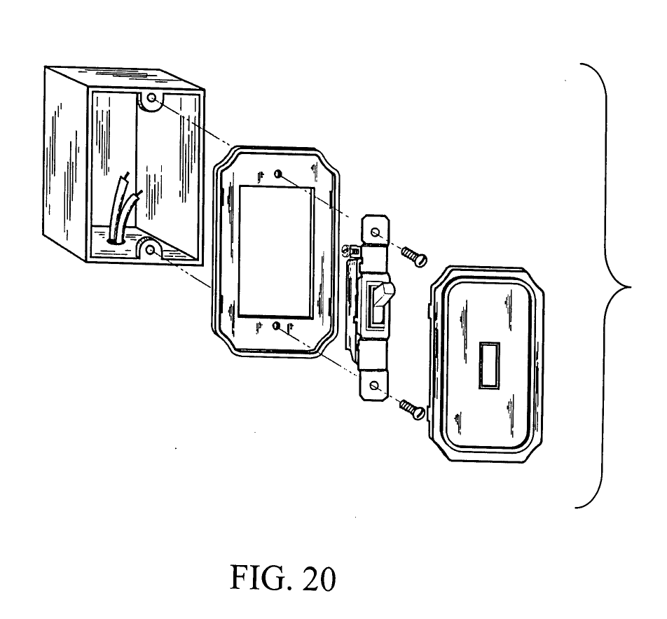

FIG. 20 is a perspective view of the third alternative embodiment for the cover plate assembly of the present invention with a toggle switch mechanism having a simple yoke plate. Ears for alignment and threaded screw holes at yoke plates of prior art for conventional cover plates are useless for the present invention.

As it is seen, the cover plate assembly of the present invention applies to any switch mechanisms or devices having simple yoke plates with screws holes at the yoke plate positioned in universal standard.

Alternatively, the structure of the cover plate assembly of the present invention can be used for other purposes such as for door lock covers and wall-mounted metal pictures. Noble surface appearance of the metal picture is super for wall decoration.

While certain preferred and alternative embodiments of the invention have been set forth for purposes of disclosure, modifications to the disclosed embodiments as well as other embodiments thereof may occurred to those skilled in the art. Accordingly, the appended claims are intended to cover all embodiments of the invention and modifications thereof which do not depart from the spirit and scope of the invention.

Having thus described the invention, what is claimed as new and desired to be secured by Letters Patent is as follows:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. In combination:
a cover plate assembly having a wall box device therein,
said wall box device adapted for mounting to a wall box and having a control member and a yoke plate, the yoke plate being attached to the control member and having openings spaced apart for alignment with screw holes in said wall box,
said cover plate assembly including a face plate and an apertured base plate receiving said wall box device, said face plate and said base plate having snap connector structure for connecting said face plate to said base plate, and said cover plate assembly having openings spaced apart for alignment with said wall box screw holes, and
at least one fastener for securing said combination to said wall box.

16. The combination of claim 15 wherein said cover plate assembly at least partially encloses said wall box device.

17. The combination of claim 15 wherein said control member has front and back surfaces separated from one another at said yoke plate, said back surface being received by said base plate aperture.

18. The combination of claim 15 wherein said wall box device is mounted to said base plate, said base plate being secured to said wall box.

19. The combination of claim 15 wherein said fastener is a mechanical fastener which secures the cover plate assembly to the screw holes of said wall box.

20. The combination of claim 15 wherein said cover plate assembly openings comprise circular openings in said base plate which are adapted for being fastenably secured to said wall box.

21. The combination of claim 19 wherein said fastener is threaded for securing said base plate circular openings to said wall box screw holes using at least one threaded fastener.

22. The combination of claim 20 wherein said circular base plate openings are two and said threaded fasteners are two, whereby each threaded fastener passes through one of said base plate circular openings, said threaded fasteners extending into said wall box screw holes.

23. The combination of claim 15 wherein said face plate has at least one orifice aligned with and adapted for receiving the control member.

24. The combination of claim 15 wherein said snap connector structure includes at least one elongated snap connector and at least one snap receiver adapted to receive the elongated snap connector.

25. The combination of claim 23 wherein the snap connector projects from the periphery of said face plate and the snap receiver is generally associated with the base plate, the snap connector and snap receiver being geometrically located in relation to one another and forming an interlocking connection for said cover plate assembly.

26. The combination of claim 15 wherein said face plate has at least one opening located in association with the lateral side of the face plate, said lateral opening being adapted for releasably separating the interlocking snap connector structure.

27. The combination of claim 15 wherein said cover plate assembly is fabricated from a metallic material, wherein the face plate has a thickness of approximately 0.8 millimeters.

28. The combination of claim 15 wherein said face plate is fabricated from steel plate and the base plate is fabricated from a flame retardant material.

29. The combination of claim 15 wherein the cover plate assembly comprises a three dimensional wall decoration.

30. In combination:
a cover plate assembly with a wall box device therein;
said wall box device adapted for mounting to a wall box and having a control member and a yoke plate, the control member having a front and back surfaces, the yoke plate being attached to the control member, separating said front from said back surfaces, and having openings spaced apart for alignment with screw holes in said wall box;
said cover plate assembly including a face plate and an apertured base plate, said face plate and said base plate connected to each other with a snap connecting structure including an elongated snap connector projecting from the periphery of said face plate and a snap receiver being generally associated with said base plate, said snap connectors being generally geometrically located in relation to one another, said snap connectors and snap receivers connecting said face plate to said base plate;
said face plate having at least one orifice aligned with and adapted for receiving the control member and one lateral opening located in association with the lateral side of the face plate the lateral opening being adapted for releasably separating the interlocking snap connector structure;
said apertured base plate receiving said back surface of said wall box device and two circular openings spaced apart for alignment with said wall box screw holes;
said cover plate assembly at least partially enclosing said wall box device; and
two threaded fasteners securing said combination to said wall box, wherein each of said threaded fasteners pass through one of said base plate circular openings, extending into said wall box screw holes.
